(19) United States
(12) Patent Application Publication
(10) Pub. No.: US 2005/0242176 A1
(43) Pub. Date: Nov. 3, 2005

(54) RFID-based system and method of conducting financial transactions

(75) Inventors: Pierre A. Roberge, Toronto (CA); Renah Persofsky, Aurora (CA); Debbie Gamble, Toronto (CA); Steve Doswell, Toronto (CA)

Correspondence Address: BERESKIN AND PARR, 40 KING STREET WEST, BOX 401, TORONTO, ON, M5H 3Y2, CA

(73) Assignee: Dexit Inc., Toronto (CA)

(21) Appl. No.: 10/833,015

(22) Filed: Apr. 28, 2004

(51) Int. Cl. G06K 15/00; G06F 17/60; G06F 7/08

(52) U.S. Cl. 235/383; 705/16

(57) ABSTRACT

A RFID-based method and system for conducting a financial transaction is disclosed. The method includes the steps of: (a) communicating to a RFID reader a transaction amount for completing the financial transaction; (b) displaying the transaction amount on the RFID reader; and (c) placing a RFID tag in close proximity to the reader to communicate acceptance of the transaction by the consumer. The system includes a RFID reader capable of communicating with a RFID tag and a POS terminal. The RFID reader displays a transaction amount to the consumer. The RFID reader is capable of detecting acceptance of the transaction by the consumer when the RFID tag is placed in close proximity to the reader. The system also includes a processing system for completing the transaction which communicates with the POS terminal.

### FIELD OF THE INVENTION

The invention relates to radio frequency identification (RFID) technology, and in particular, to RFID-based systems and methods for conducting financial transactions.

### BACKGROUND OF THE INVENTION

There has been an ongoing effort to find alternatives to cash payments for conducting financial transactions. A number of these alternatives, such as credit cards and debit cards, are well known. However, credit cards and debit cards have a number of disadvantages as cash replacements, particularly for small-value transactions. These disadvantages include speed of the transaction, transaction fees, and security of the transaction.

Small-value transactions, such as, for example, fast food or convenience store purchases, typically have a low profit margin and depend on high volume for profitability. Accordingly, small-value transactions are highly cost-sensitive and speed-sensitive. The combination of the cost and transaction duration of credit and debit card transactions make these alternatives unsuitable for small-value transactions.

RFID is a well known contactless data exchange technology that uses compact electronic tags (also known as transponders) to store information, and a wireless radio frequency (RF) reader (also known as a transceiver) to capture the information. There are several types of RFID transponders. One type which has its own power supply is known as an “active” transponder. In contrast, a “passive” transponder has no power supply of its own, and is energized by a RF signal from the reader when placed in close proximity to the reader.

Several RFID-based transaction systems are currently in operation. One example of such systems has been implemented by operators of gasoline station chains. These businesses provide RFID tags to consumers which interface with RFID readers built into the pumps at the stations. In such systems, the consumer RFID tag essentially acts as a proxy for a credit card number of a credit card issued to a particular consumer. In other words, the information stored on the RFID tag is used to locate the credit card number of the consumer on the computer system managed by the gasoline station chain. Accordingly, such a system suffers from the same disadvantages of credit card systems described above.

Accordingly, there is a need for RFID-based transaction systems and methods which reduce transaction duration and cost, as well as provide improved transaction non-repudiation and security.

### SUMMARY OF THE INVENTION

According to a first aspect of the invention, a method of conducting a financial transaction between a consumer and a merchant is provided. The method comprises the steps of: (a) communicating to a RFID reader a transaction amount for completing the financial transaction; (b) displaying the transaction amount on the RFID reader; and (c) placing a RFID tag in close proximity to the reader to communicate acceptance of the transaction by the consumer.

Preferably, the transaction amount is displayed on the RFID reader so that it is visible to the consumer. More preferably, the method includes the step of completing the transaction.

According to a second aspect of the invention, a system for conducting a financial transaction between a consumer and a merchant is provided. The system comprises: (a) a RFID tag; (b) a RFID reader adapted to display a transaction amount to the consumer, wherein the RFID reader is adapted to detect acceptance of the transaction amount by the consumer when the RFID tag is placed in close proximity with the RFID reader; (c) a Point of Sale (POS) terminal adapted for communication with the RFID reader; and (d) a processing system adapted for communication with the POS terminal, wherein the processing system is adapted to complete the transaction.

Preferably, the processing system comprises: a transaction server adapted for communication with the POS terminal; a business tier in communication with the transaction server; and a database. The business tier is adapted for communication with the database.

### BRIEF DESCRIPTION OF THE DRAWINGS

In the accompanying drawings:

FIG. 1 shows a schematic view of a RFID-based transaction system according to a preferred embodiment of the present invention;

FIG. 2 is a plan view of the front face of a RFID reader for the preferred embodiment;

FIG. 3 is a flow diagram showing a purchase transaction according to the preferred embodiment of the present invention; and

FIG. 4 is a flow diagram showing the consumer enrollment process for the preferred embodiment.

### DETAILED DESCRIPTION OF THE PREFERRED EMBODIMENT

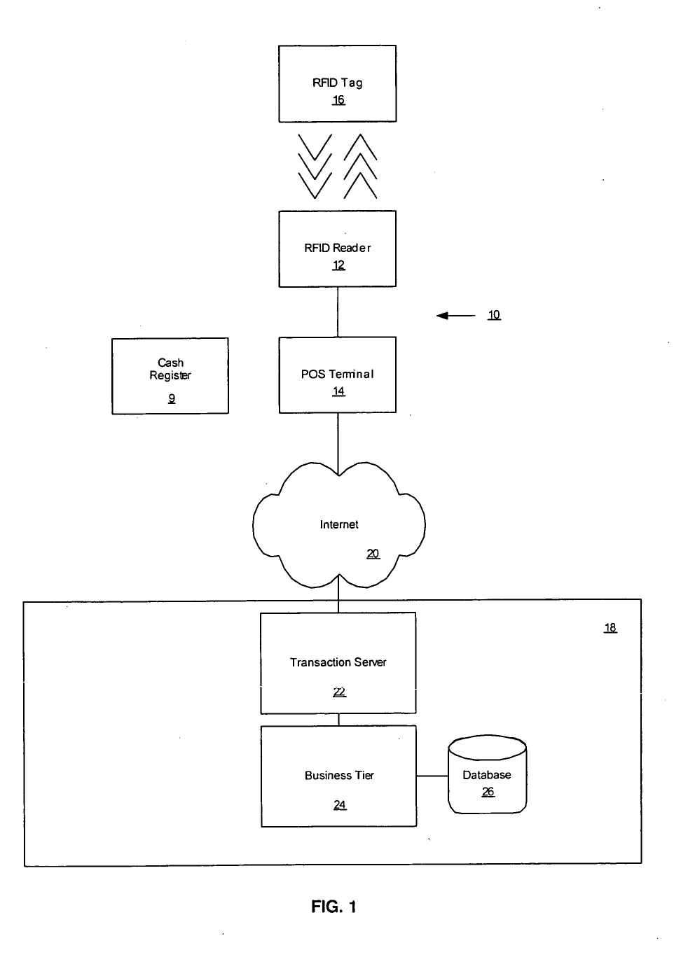

FIG. 1 shows a conventional cash register 9 and a RFID-based system 10 for conducting financial transactions, according to a preferred embodiment of the present invention. Preferably, the system 10 provides the functionality described herein to a number of merchants and consumers who enter into agreements with a system operator (directly or indirectly) to use the service enabled by the system. As part of the agreement with the system operator, the consumer opens a consumer account, such as for example a prepaid account with the system operator or an intermediary, as discussed below.

Alternatively, the system operator may enter into an agreement with one or more issuers or acquirers. The issuer may be any large commercial organization, such as a financial institution, telephone company or a wireless network operator. The acquirer may be a financial institution or a credit or debit card processing company. The acquirer may then enter into agreements with the merchants and the issuer may enter into agreements with consumers to provide access to the system 10. In this alternative embodiment, there may be several acquirers who conduct transactions on the system 10 operated by the system operator. Alternatively, either or both of the acquirer and issuer may be the system operator. Finally, a merchant may offer access to the system 10 to its customers. In this embodiment, the merchant would also act as the system operator, acquirer, and issuer.

Referring to FIG. 1, the system 10 includes a RFID reader 12, which is connected to a stand-alone point-of-sale (POS) terminal 14, such as a POS terminal used for credit card and debit transactions. Preferably, the RFID reader 12 is a ISO 14443 compatible RFID reader which is capable of communicating with a POS. It will be understood by those skilled in the art that the RFID reader 12 may be a RFID reader which is compatible with any other suitable standard.

The POS terminal 14 is a conventional POS terminal 14 modified to offer transactions using the system 10 exclusively or as an additional option (to credit and debit card transactions). The POS terminal 14 communicates with the RFID reader 12 by a serial connection using the RS 232 standard.

Although in the preferred embodiment of the system 10, the RFID reader 12 and POS terminal 14 are two stand-alone devices, it will be understood by those skilled in the art that the functionality of the RFID reader 12 and POS terminal 14 may be combined into a single device. In addition, the functionality of the cash register 9 may be combined with the functionality of the RFID reader 12 and/or POS terminal 14 into a single device.

The POS terminal 14 and the RFID reader 12 are located on the premises of the merchant. If the merchant has a number of business locations, the POS terminal 14 and RFID reader 12 may be located at each business location for a particular merchant. If a business location has more than one payment lane, the RFID reader 12 and POS terminal 14 may be deployed in each payment lane or shared across several payment lanes.

The RFID reader 12 is capable of communicating with a RFID tag 16 when the RFID tag 16 is placed in close proximity to the RFID reader 12. “Close proximity” preferably means that the distance between the RFID tag 16 and RFID reader 12 is about 10 cm or less. Preferably, the RFID tag 16 has to be in contact with the RFID reader 12 for communication.

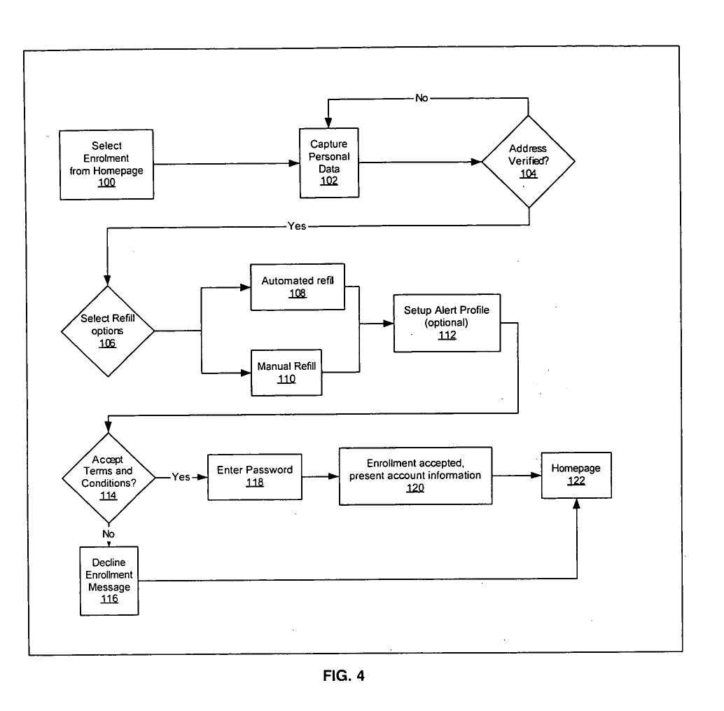

The RFID tag 16 is a conventional passive RFID transponder which complies with the ISO 14443 standard for contactless memory chips, or any other suitable RFID transponder, such as a transponder which complies with any other RFID-based communication standard. The RFID tag 16 may have a compact design suitable for attaching to a key chain or to a device, such as a cell phone, typically carried by the consumer. The RFID tag 16 may also be embedded into a plastic card having dimensions similar to that of a credit card. The RFID tag 16 is issued to a consumer by the issuer or system operator when the consumer enrolls with the issuer or system operator and opens a consumer account. The enrollment process is described in detail below with reference to FIG. 4.

Continuing to refer to FIG. 1, the POS terminal 14 communicates with a processing system 18 in any suitable fashion. The processing system 18 is operated by the system operator and is preferably connected to the POS terminal 14 via the Internet 20 using the TCP/IP HTTPS protocol and 128 bit encryption. It will be understood by those skilled in the art that any other suitable network (such as for example a wide area network (WAN) or a local area network-(LAN)), protocol, or encryption method may be utilized for communication between the POS terminal 14 and the processing system 18.

The messages between the POS terminal 14 and the processing system 18 are constructed using the IS08583 standard for financial transactions. It will be understood by those skilled in the art that any other suitable message standard or format may be utilized for communication between the POS terminal 14 and processing system 18, such as for example, a proprietary message format specific to a particular financial institution. The POS terminal 14 is preferably connected to the Internet 20 by any suitable always-on Internet connection to minimize the transaction duration.

The processing system 18 includes a transaction server 22, a business tier 24, and a database 26. The transaction server 22 is any suitable server capable of checking the integrity of the IS08583 message, message encryption and decryption, and protocol conversion. Preferably, the transaction server 22 runs a Java servlet which provides an interface to the POS terminal 14 for the Internet payment transaction. The Java servlet enables the transaction server 22 to handle the transaction messages from and to the POS terminal 14 in the same way that a conventional web server handles requests from a conventional client web browser. Conversely, the POS terminal 14 includes software which allows it to request information from the transaction server 22 in a manner analogous to a client web browser.

The business tier 24 is preferably a Java software module which performs the database look-ups and executes the payment authorization logic (as described in detail below) required to conduct the transaction. The business tier 24 also generates the alerts to the consumer, as discussed below.

The database 26 may be any suitable database, such as an Oracle™ database, which stores the consumer credentials, merchant credentials, credentials of the POS terminal 14, security-related information, and transaction-related information.

The transaction server 22, business tier 24, and database 26 may each be implemented on one or more servers or other computers, or they may be software instances all running on a single server, or any combination thereof.

For clarity, only one RFID reader 12, one POS terminal 14, and one RFID tag 16 are shown in FIG. 1. However, it will be understood by those skilled in the art that the processing system 18 is capable of communicating with many POS terminals. Each of these POS terminals may be connected to a corresponding RFID reader. Preferably, at least one POS terminal and RFID reader are installed in each participating business location of each merchant. In addition, each consumer enrolled with the system operator would be issued the RFID tag 16, and each RFID reader 12 is capable of reading the RFID tag 16 issued to any participating consumer by the system operator or its issuers (although the RFID reader 12 is configured to read only one RFID tag 16 for a particular transaction).

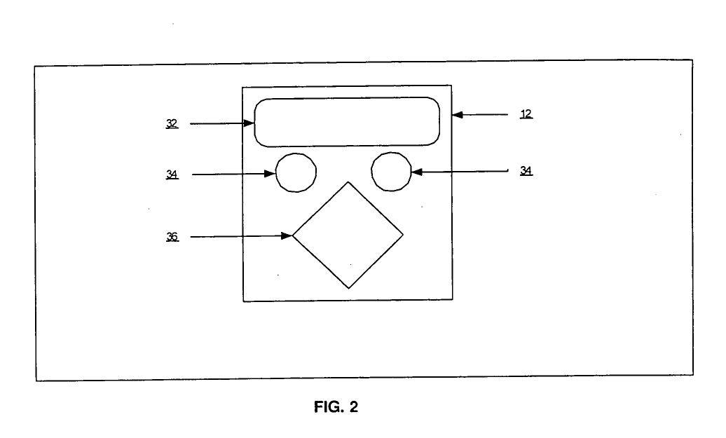

Referring to FIG. 2, the RFID reader 12 includes a display 32 (such as an LCD display), indicator lights 34, and a speaker 36 capable of audible voice messages. The remaining components of the RFID reader 12 are well known and are present in any commercially available ISO 14443 compatible RFID reader.

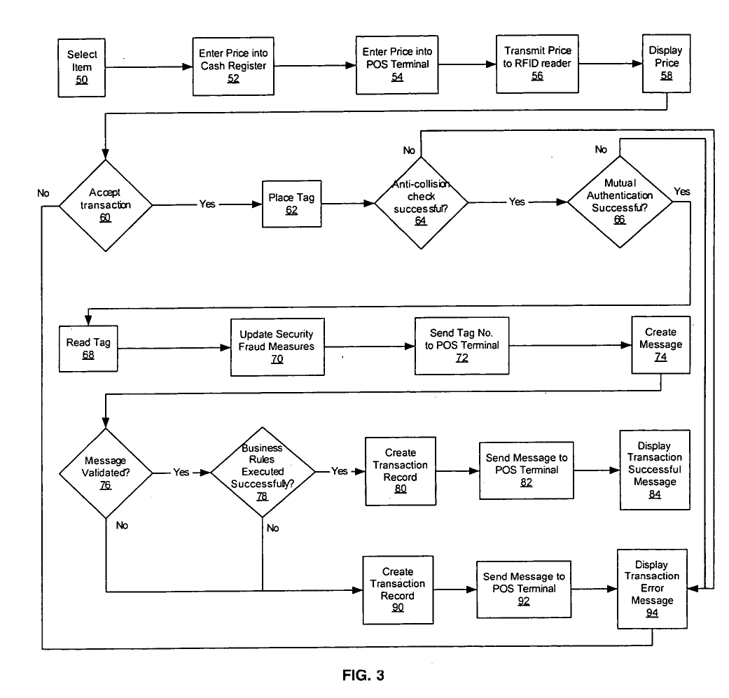

The operation of the present invention will now be described with reference to FIGS. 1-3.

The transaction begins at step 50, where the consumer selects an item or items for purchase and informs the store clerk of his/her intention. The store clerk may work at the business location of a participating merchant, such as for example in one fast food outlet (business location) for a particular fast food chain (participating merchant).

At optional step 52, the clerk enters the price of the item(s) into the cash register 9 and calculates the total transaction amount (including taxes and any other applicable fees). The cash register 9 displays the total transaction amount. This step may not be required if the transaction amount is easily calculated, and may be communicated to the consumer in other ways (such as orally).

At step 54, the consumer informs the store clerk that the consumer wishes to conduct the transaction using the RFID-based system 10 according to the preferred embodiment of the present invention. The clerk selects the system 10 as the consumer's choice for conducting the transaction and enters the transaction amount into the POS terminal 14. In the embodiment where the POS terminal 14, cash register 9, and/or RFID reader 12 and/or their functionality are combined into a single device, the transaction amount calculated by the cash register 9 may simply be transmitted to the POS terminal 14 and RFID reader 12, thereby eliminating the need to manually enter the transaction amount into the POS terminal 14.

At step 56, the POS terminal 14 communicates the transaction amount to the RFID reader 12.

At step 58, the RFID reader 12 displays the transaction amount and a message to the consumer to place the RFID tag 16 in close proximity to the RFID reader 12. These messages are displayed on the display 32 of the RFID reader 12. The RFID reader 12 may also include the functionality to synthesize and transmit via the speaker 36 a voice message identifying the transaction amount to the consumer. The RFID reader 12 may also turn on a green light on the indicator lights 34 in order to indicate to the consumer that the RFID reader 12 is ready to read the RFID tag 16. The RFID reader 12 then activates an RF signal in an attempt to read the RFID tag 16.

At decision diamond 60, the consumer decides whether to accept the transaction. If the consumer accepts the transaction, the process moves to step 62.

If the consumer does not wish to accept the transaction, the consumer will not place his/her RFID tag 16 in close proximity to the RFID reader 12. If the RFID reader 12 is not able to read the RFID tag 16 within a predetermined period of time (such as 10 seconds), the transaction will time out and the process will move to step 94 where a transaction error message is displayed on the RFID reader 12 and POS terminal 14.

At step 62, the consumer places his/her RFID tag 16 in close proximity to the RFID reader 12 to indicate acceptance of the transaction.

At decision diamond 64, the RFID reader 12 initiates communication with the RFID tag 16 by performing anti-collision verification to ensure that multiple RFID tags are not in close proximity to the RFID reader 12. The anti-collision verification checks to ensure only one RFID tag 16 has been located by the RFID reader 12. The anti-collision verification algorithms are well known and are built into ISO 14443 compliant RFID readers and transponders. If anti-collision verification is successful, the process moves to decision diamond 66.

If anti-collision verification is not successful, the process moves to step 94.

At decision diamond 66, the RFID reader 12 and tag 16 perform mutual authentication. Authentication is performed by the RFID reader 12 verifying a unique identifier stored on the RFID tag 16. In the preferred embodiment, a cryptographic shared secret security schema is used to perform authentication. Such cryptographic technology is commercially available from a variety of RFID tag manufacturers. If the authentication is successful, the process moves to step 68.

If authentication is not successful, the process moves to step 94.

At step 68, the RFID reader 12 reads the memory of the consumer's RFID tag 16. Preferably, the RFID reader 12 reads a tag number from the RFID tag 16. The tag number is unique to each RFID tag issued.

The RFID reader 12 may read additional information stored on the RFID tag 16, such as the expiration date of the tag, the fraud -measures (discussed below), and other non-personal proprietary data, such as issuer identification code, currency of the customer account, language of choice, etc. At this point, the indicator lights 34 on the RFID reader 12 are turned off and a beep may be sounded by the speaker 36 to notify the consumer that the RFID tag 16 has been read.

At step 70, the fraud measures for the RFID tag 16 are updated. The fraud measures are behavior-based criteria which reflect the transaction history and habits of the consumer, in an effort to detect fraudulent use of the RFID tag 16 by looking for unusual behavior. One example of behavior-based information stored on the RFID tag 16 is the number of transactions conducted in the lifetime of the RFID tag 16.

At step 72, the RFID reader 12 sends the tag number to the POS terminal 14. The POS terminal 14 displays a “transaction processing” message.

At step 74, the POS terminal 14 creates a message which includes the following:
time stamp of the transaction;
transaction amount;
tag number read from the RFID tag 16;
identification number of POS terminal 14;
identification number of the business location (stored on the RFID reader 12);
identification number of the merchant at whose business location the POS terminal 14 is located (also stored on the RFID reader 12);
the transaction type (e.g. purchase, void, etc.); and
security-related data (such as a digital signature stored on the RFID tag 16).

Preferably, the transaction type is either a purchase or a void. The transaction type may also include a transaction to provide the consumer account balance, tag activation, or account replenish transaction. In the case of step 74, the transaction type is a purchase transaction. The message is transmitted to the processing system 18 via the Internet 20.

At decision diamond 76, the transaction server 22 of the processing system 18 receives and decrypts the message from the POS terminal 14. The transaction server 22 may also authenticate the RFID tag 16 in order to prevent fraudulent replay attacks and to avoid incurring processing costs. The transaction server 22 verifies the message format received from the POS terminal 14, and either validates or rejects the message. If the message is validated, it is translated into an internal protocol used by the processing system 18 and is forwarded to the business tier 24. The internal protocol is a tokenized version of a single string of data. In particular, the message received from the POS terminal 14 is broken up into several portions, and each portion is used as an input parameter for processing by the business tier 24. These portions include information specific to the RFID tag 16, information specific to the merchant, and information specific to the POS terminal 14.

If the message is validated, the process moves to decision diamond 78. If the message is not validated, the process moves to step 90.

At decision diamond 78, the business tier 24 executes the business rules, as described below. Specifically, the business tier 24 locates a consumer account number which is linked to the tag number. In this manner, the consumer account number does not have to be changed if the consumer's RFID tag is reported as lost or stolen. The consumer is simply issued another RFID tag with a new tag number and the consumer account number is linked to the new tag number.

The business tier 24 verifies the status of the consumer account, the status of the POS terminal 14, and the merchant account by looking up the required information on the database 26 using the information provided in the message from the POS terminal 14. The database 26 may include information on whether the various parties (consumer, business location, merchant, acquirer) are still participating in the system 10 and whether each party is in good standing with respect to fees owed to any other party.

If each party is confirmed to be in good standing, the business tier 24 looks up the balance of the consumer account from the database 26. The business tier 24 compares the balance with the transaction amount to determine whether the consumer has sufficient funds in the consumer account to satisfy the transaction amount.

If all of the above business rules are executed successfully, the process moves to step 80. If not, the process moves to step 90.

At step 80, the business tier 24 creates a transaction record and posts it to the database 26. The relevant records, such as the consumer account and the merchant account are updated. The process then moves to step 82.

At step 82, the business tier 24 communicates the transaction record to the transaction server 22, which in turn transmits the transaction record to the POS terminal 14 via the Internet 20. The transaction server 22 encodes the transaction record from the internal protocol used by the business tier 24 into the ISO 8583 message and encrypts the message.

At step 84, the POS terminal 14 displays to the clerk and the RFID terminal 12 displays to the consumer on the display 32 that the transaction was successful.

As discussed above, if the message is not validated or if the business rules are not executed successfully, the process moves to step 90. At this step, the business tier 24 creates an audit trail transaction record. The process then moves to step 92.

At step 92, the business tier 24 sends the audit trail transaction record to the transaction server 22. The transaction server 22, creates the ISO 8583 message, encrypts the message, and sends it to the POS terminal 14 via the Internet 20. The process then moves to step 94 (discussed above).

The present invention provides numerous advantages over the prior art. In particular, the preferred embodiment of the invention provides improved non-repudiation by displaying the transaction amount to the consumer on the RFID reader 12, and permitting the consumer to indicate acceptance of the transaction by placing the RFID tag 16 in close proximity to the RFID reader 12. The preferred embodiment of the present invention provides improved security by providing mutual authentication between the RFID reader 12 and tag 16. In addition, the present invention allows a single RFID-based system to be used by many different merchants, and to be shared by multiple issuers and acquirers.

FIG. 4 shows the process for enrollment of the consumer with the system according to the preferred embodiment of the present invention. The process starts at step 100, where the consumer accesses a website of the issuer (or the system operator if the system operator is also the issuer) with any suitable Internet-enabled device and selects the enrollment link on the website.

At step 102, the consumer is presented with a web form for capturing personal information, such as the consumer's name, address, telephone number, and other marketing measurement information (such as gender, birthday, etc.). After the form is complete the consumer submits the form by clicking on a “Submit” button, and the process moves to decision diamond 104.

At decision diamond 104, the address information provided by the consumer is automatically submitted by the issuer website to a conventional address verification service. If the address of the consumer is verified, the process moves to decision diamond 106. If not, the process moves back to step 102, where the consumer is requested to re-enter his/her personal information.

At decision diamond 106, the consumer is asked to choose between two options for replenishing his/her consumer account. If the consumer chooses the automatic refill option, the process moves to step 108. If the consumer chooses the manual refill option, the consumer receives a confirmation message at step 110. The process then moves to step 112.

At step 108, the consumer is presented with an image of a pre-authorized debit (PAD) form in any suitable format, such as PDF format. The consumer is presented with instructions to print out and complete the form and to provide the form to his/her issuer. The process moves to step 112.

The consumer may complete the PAD process after enrollment by sending the PAD form to the issuer. The PAD authorizes the issuer to debit the consumer's financial institution account for transfer of an amount authorized by the consumer to the consumer account every time the consumer account falls below a predetermined threshold.

At step 112, the consumer is prompted to set-up an alert profile. The alerts are preferably email alerts, but may also be any other suitable type of alerts, such as for example, telephone voice messages or SMS (Short Message Service) messages. The types of alerts may include: (i) periodic (such as daily) notifications of account balance when the balance in the consumer account falls below a certain threshold, (ii) notification alerts when the balance in the consumer account falls below a certain threshold, (iii) notification alerts when the account has been replenished successfully, or (iv) alerts about special offers from the issuer. The consumer may choose not to receive any alerts. The process then moves to decision diamond 114.

At step 114, the consumer is asked to review the terms and conditions of use and indicate whether he/she accepts or declines the terms. If the consumer declines the terms of use, the process moves to step 116. If the consumer accepts, the process moves to step 118.

At step 116, the consumer is presented with an “enrollment declined” message. The process then moves to step 122.

At step 118, the consumer is prompted to select a password that he/she will use to access the consumer account and related services on the web and through other channels (such as IVR or call center).

At step 120, the consumer is presented with a message that his/her enrollment has been accepted and is provided with the consumer account information, such as the consumer account number.

At step 122, the consumer is redirected back to the web page where the enrolment process began.

In the event the consumer chooses the manual refill option at step 110 of the enrollment process, the consumer may replenish his/her consumer account by setting up his/her consumer account as a biller through his/her financial institution's Internet banking website or through some other channel (such as telephone banking), as is well known in the art. The consumer can then use the bill payment functionality of the Internet banking website or telephone banking service to replenish the consumer account as required.

Following a successful enrolment, the system 10 may issue a request to a fulfillment bureau to send a consumer package, including the RFID tag 16 and other printed material, to the consumer. The fulfillment bureau then confirms to the system operator that the RFID tag 16 has been sent and provides the tag number sent to the consumer to the system operator.

In the consumer package, the consumer is asked to activate his/her RFID tag 16 upon receipt (as a precaution against misuse of lost or stolen tags).

It will be understood by those skilled in the art that the enrollment process described above is only one option for a consumer to enroll in the system, and many other options may be used. For example, the consumer may enroll by telephone with a call center agent, or in person at a issuer or system operator location.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a system or method to address each and every problem sought to be solved by the present invention, for it is to be encompassed by the present claims.

1. A method of conducting a financial transaction between a consumer and a merchant, the method comprising:
a) communicating to a RFID reader a transaction amount for completing the financial transaction;
b) displaying the transaction amount on the RFID reader;
c) placing a RFID tag in close proximity to the reader to communicate acceptance of the transaction by the consumer.

2. The method of claim 1, wherein the transaction amount is displayed on the RFID reader such that the transaction amount is visible to the consumer.

3. The method of claim 2, further comprising completing the transaction.

4. The method of claim 3, wherein the completing step comprises mutual authentication between the RFID tag and the RFID reader.

5. The method of claim 4, wherein the completing step comprises the RFID reader performing anti-collision verification with the RFID tag.

6. The method of claim 5, wherein the competing step comprises the RFID reader reading a tag number from the RFID tag.

7. The method of claim 6; wherein the completing step comprises updating a fraud measure on the RFID tag.

8. The method of claim 7, wherein the completing step comprises the RFID reader sending the tag number to a POS terminal.

9. The method of claim 8, wherein the completing step comprises the POS terminal creating a message to a processing system, the message comprising: a transaction time stamp, the transaction amount, the tag number, a transaction type, a POS identifier, and a merchant identifier.

10. The method of claim 9, wherein the completing step comprises the POS terminal encrypting the message and sending the message to a transaction server.

11. The method of claim 10, wherein the completing step comprises a transaction server decrypting the message and translating the message to an internal protocol.

12. The method of claim 11, wherein the completing step comprises a business tier verifying a consumer account linked to the tag number, a merchant account, and a POS status information to determine if the consumer account, the merchant account and a POS location in good standing.

13. The method of claim 11, wherein the completing step comprises a business tier checking a consumer account number linked to the tag number to determine if the balance in the consumer account is sufficient to satisfy the transaction amount.

14. The method of claim 13, wherein the completing step comprises the business tier creating a transaction record and posting the transaction record to a database.

15. The method of claim 14, wherein the completing step comprises the POS terminal displaying a transaction successful message.

16. The method of claim 8, wherein the communicating step comprises the POS terminal transmitting the transaction amount to the RFID reader.

17. The method of claim 16, wherein the communicating step comprises entering the transaction amount into the POS terminal.

18. The method of claim 17, wherein the communicating step comprises calculating the transaction amount on a cash register.

19. The method of claim 1 further comprising providing the RFID tag to the consumer.

20. The method of claim 19, wherein the providing step comprises enrolling the consumer with an issuer.

21. The method of claim 20, wherein the enrolling step comprises opening a consumer account and depositing money into the consumer account.

22. The method of claim 1, comprising communicating to the consumer a notification about a consumer account, wherein the consumer account comprises a prepaid account.

23. The method of claim 22, wherein the notification comprises information about the balance of the consumer account.

24. A system for conducting a financial transaction between a consumer and a merchant, the system comprising:
a) a RFID tag;
b) a RFID reader adapted to detect acceptance of the transaction amount by the consumer when the RFID tag is placed in close proximity with the RFID reader;
c) a POS terminal adapted for communication with the RFID reader; and
d) a processing system adapted for communication with the POS terminal, wherein the processing system is adapted to complete the transaction.

25. The system of claim 24, wherein the transaction processing system comprises:
a) a transaction server adapted for communication with the POS terminal;
b) a database; and
c) a business tier adapted for communication with the transaction server and the database.

26. The system of claim 24, wherein the RFID reader comprises a display visible to the consumer, the display being adapted to show the transaction amount to the consumer.

27. The system of claim 26, wherein the RFID reader comprises a speaker adapted for voice communication of transaction information to the consumer.

28. The system of claim 27, wherein the transaction information comprises the transaction amount.

29. The system of claim 27, wherein the RFID reader comprises at least one indicator light.

30. The system of claim 27, wherein the RFID reader is ISO 14443 compatible.

31. The system of claim 25, wherein the POS terminal and the transaction server communicate via the Internet using TCP/IP HTTPS protocol.

32. The system of claim 31, wherein the POS terminal and the transaction server communicate via messages compatible with the ISO 8583 standard for financial transactions.

33. The system of claim 32, wherein the business tier is adapted to receive messages from the transaction server and to execute a business logic for the financial transaction.

34. The system of claim 33, wherein the database is adapted to store consumer credential information, merchant credential information, POS credential information, security-related information, and transaction-related information.

35. The system of claim 25, wherein the RFID reader is adapted to read a tag number stored on the RFID tag, the tag number being linked to a consumer account number stored on the database.
